(19) United States
(12) Patent Application Publication
(10) Pub. No.: US 2025/0102706 A1
(43) Pub. Date: Mar. 27, 2025

(54) ANTI-GLARE LAYERS AND DISPLAY PANELS

(71) Applicant: Shenzhen China Star Optoelectronics Semiconductor Display Technology Co., Ltd., Shenzhen (CN)

(72) Inventor: Aibing BAO, Shenzhen (CN)

(73) Assignee: Shenzhen China Star Optoelectronics Semiconductor Display Technology Co., Ltd., Shenzhen (CN)

(21) Appl. No.: 18/399,191

(22) Filed: Dec. 28, 2023

(30) Foreign Application Priority Data
Sep. 25, 2023 (CN) 202311248091.6

(51) Int. Cl. G02B 1/111; C08K 3/22; C08K 5/00; G02B 1/14

(52) U.S. Cl. CPC G02B 1/111; C08K 3/22; C08K 5/0091; G02B 1/14; C08K 2201/005

(57) ABSTRACT

Embodiments of the present disclosure provide an anti-glare layer and a display device. The anti-glare layer includes a substrate, an anti-glare sub-layer disposed on a side of the substrate, and a hardened sub-layer disposed on a side of the anti-glare sub-layer away from the substrate; the anti-glare sub-layer includes a first resin matrix and composite particulates dispersed in the first resin matrix; the composite particulates includes metal oxide particulates and a titanate-based compound connected to a surface of the metal oxide particulates; and a difference between a refractive index of the composite particulates and a refractive index of the first resin matrix is greater than 0.25.

### CROSS-REFERENCE TO RELATED APPLICATION

The present disclosure claims the priority to and benefit of Chinese Patent Application No. 202311248091.6, filed on Sep. 25, 2023, the disclosure of which is incorporated herein by reference in its entirety.

### TECHNICAL FIELD

The present disclosure relates to the field of display, and in particular, to anti-glare layers and display devices.

### BACKGROUND

During the use of a display device, an anti-glare coating layer is usually installed on the display side of the display device to achieve the anti-glare function to avoid light reflection and image reflection caused by external strong light. Usually, the anti-glare coating layer has a surface with a concave-convex structure. However, the concave-convex structure is difficult to obtain a good mechanical property and is susceptible to scratch damage and easy to fail, making it difficult to improve the mechanical properties and maintain the anti-glare performance of the surface of the display device.

Therefore, there is a need for an anti-glare layer and a display device to solve the above-mentioned technical problems.

### SUMMARY

Embodiments of the present disclosure provide a display panel, including:
a substrate;
an anti-glare sub-layer disposed on a side of the substrate; and
a hardened sub-layer disposed on a side of the anti-glare sub-layer away from the substrate;
in which the anti-glare sub-layer includes a first resin matrix and composite particulates dispersed in the first resin matrix, and the composite particulates include metal oxide particulates and a titanate-based compound connected to a surface of the metal oxide particulates; and
in which a difference between a refractive index of the composite particulates and a refractive index of the first resin matrix is greater than 0.25.

Embodiments of the present disclosure further provide a display device including a display panel and an anti-glare layer disposed on a light output side of the display panel, in which the anti-glare layer includes:
a substrate;
an anti-glare sub-layer disposed on a side of the substrate; and
a hardened sub-layer disposed on a side of the anti-glare sub-layer away from the substrate;
in which the anti-glare sub-layer includes a first resin matrix and composite particulates dispersed in the first resin matrix, and the composite particulates include metal oxide particulates and a titanate-based compound connected to a surface of the metal oxide particulates; and
in which a difference between a refractive index of the composite particulates and a refractive index of the first resin matrix is greater than 0.25.

### BRIEF DESCRIPTION OF THE DRAWINGS

In order to explain technical solutions in embodiments of the present disclosure more clearly, the following will briefly introduce the drawings needed to be used in description of the embodiments. Apparently, the drawings in the following description are only some embodiments of the present disclosure. For ordinary skilled in the art, other drawings can be obtained from these drawings without creative effort.

FIG. 1 is a schematic structural diagram of an anti-glare layer provided by some embodiments of the present disclosure.

FIG. 2 is a schematic structural diagram of a composite particulate of an anti-glare layer provided by some embodiments of the present disclosure.

FIG. 3 is a schematic structural diagram of a first structure of a display device provided by some embodiments of the present disclosure.

FIG. 4 is a schematic structural diagram of a second structure of a display device provided by some embodiments of the present disclosure.

### DETAILED DESCRIPTION

The following will provide a clear and complete description of the technical solutions in the embodiments of the present disclosure in conjunction with the accompanying drawings. Apparently, the described embodiments are only a part of the embodiments of the present disclosure, not all of them. Based on the embodiments of the present disclosure, all other embodiments obtained by those skilled in the art without creative effort fall within the protection scope of the present disclosure. In addition, it should be understood that specific embodiments described herein are only used for the purpose of demonstrating and explaining the present disclosure and are not intended to limit the present disclosure. In the present disclosure, the directional terms used, such as “up” and “down”, generally refer to up and down positions of the device in actual use or working state, specifically the surface directions in the drawings, unless otherwise specified, such as terms “inside” and “outside”, are specific to the contour of the device.

At present, anti-glare coating layers for display devices are difficult to obtain good mechanical properties and do not have scratch resistance due to the concave-convex structures on surfaces of the anti-glare coating layers, making it difficult to maintain the anti-glare performance.

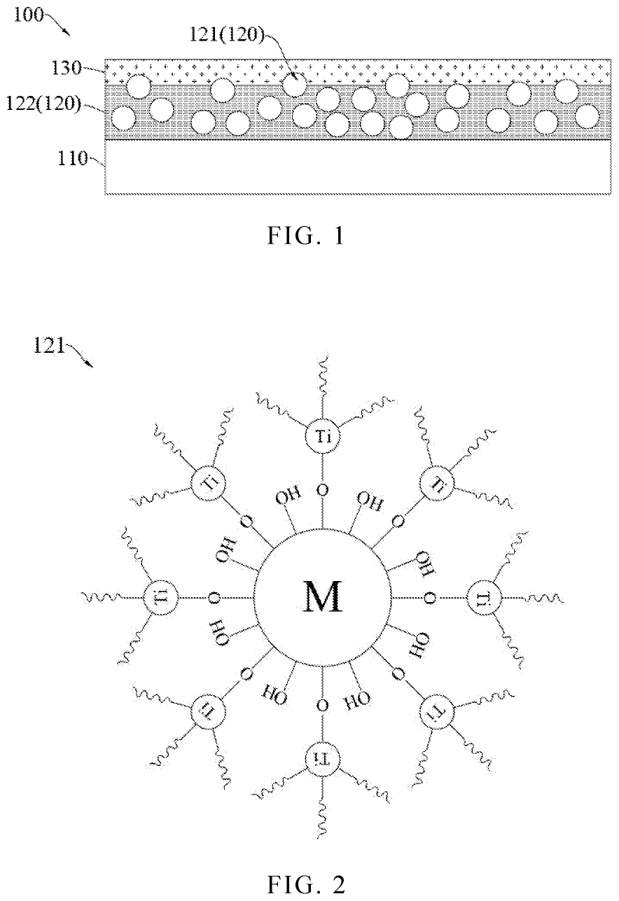

Referring to FIG. 1 and FIG. 2, embodiments of the present disclosure provide an anti-glare layer 100, including:
a substrate 110;
an anti-glare sub-layer 120 disposed on a side of the substrate 110; and
a hardened sub-layer 130 disposed on a side of the anti-glare sub-layer 120 away from the substrate 110;
in which the anti-glare sub-layer 120 includes a first resin matrix 122 and composite particulates 121 dispersed in the first resin matrix 122, and the composite particulates 121 include metal oxide particulates and a titanate-based compound connected to a surface of the metal oxide particulates; and
in which a difference between a refractive index of the composite particulates 121 and a refractive index of the first resin matrix 122 is greater than 0.25.

The embodiments of the present disclosure improve the mechanical property of the anti-glare layer 100 and protects the anti-glare sub-layer 120 with an anti-glare function by setting the hardened sub-layer 130 on a side of the anti-glare sub-layer 120. Moreover, by using the composite particulates 121 in the anti-glare sub-layer 120, and making the difference between the refractive index of at least one of the composite particulates 121 and the refractive index of the first resin matrix 122 of the anti-glare sub-layer 120 being greater than 0.25, a good anti-glare performance can be obtained.

The technical solutions of the present disclosure are described with reference to the following embodiments.

In some embodiments, the composite particulates 121 are dispersed in the first resin matrix 122. For example, the composite particulates 121 are dispersed inside the first resin matrix 122 and/or expose to a surface of the first resin matrix 122. In some embodiments, some of the composite particulates 121 are completely wrapped inside the first resin matrix 122, while some of the composite particulates 121 are not completely wrapped inside the first resin matrix 122 to partially expose to a surface of the first resin matrix 122.

In some embodiments, the composite particulates 121 have a particle size greater than or equal to 1 micrometer and less than or equal to 10 micrometers. For example, the particle size of the composite particulates 121 may be 1 micrometer, 2 micrometers, 3 micrometers, 4 micrometers, 5 micrometers, 6 micrometers, 7 micrometers, 8 micrometers, 9 micrometers, 10 micrometers, or the like. Preferably, each of the composite particulates 121 has a particle size greater than or equal to 3 micrometers and less than or equal to 5 micrometers, for example, 3 micrometers, 3.5 micrometers, 4 micrometers, 4.5 micrometers, 5 micrometers, or the like, to obtain the composite particulates 121 with a suitable particle size and uniform distribution.

Due to the negligible change in the particle size caused by the titanate-based compound connected to the surface of the metal oxide particulates, a particle size of the metal oxide particulates and the particle size of the corresponding composite particulates 121 are commensurate. The metal oxide particulates have a particle size of greater than or equal to 1 micrometer and less than or equal to 10 micrometers, for example, 1 micrometer, 2 micrometers, 3 micrometers, 4 micrometers, 5 micrometers, 6 micrometers, 7 micrometers, 8 micrometers, 9 micrometers, 10 micrometers, or the like. Preferably, the particle size of the metal oxide particulates is greater than or equal to 3 micrometers and less than or equal to 5 micrometers, for example, 3 micrometers, 3.5 micrometers, 4 micrometers, 4.5 micrometers, 5 micrometers, or the like.

In some embodiments, the metal oxide particulates may be selected from one or more particulates formed by one or more metal oxides with higher refractive indices such as zirconia, titanium oxide, zinc oxide, antimony pentoxide, cerium oxide, yttrium oxide, and the like.

In some embodiments, the titanate-based compound is obtained by the reaction of the titanate-based coupling agent and groups (such as hydroxyl or carboxyl) bonded on the surface of the metal oxide particulate.

A structure of at least one of the composite particulates 121 is shown in FIG. 2, in which M represents the metal oxide particulate.

The titanate-based coupling agent may be selected from a titanate-based coupling agent having a higher refractive index. For example, a titanate-based compound having a refractive index greater than 1.45 may be selected to enhance the refractive index of the composite particulates 121 and obtain a significant refractive index difference from the first resin matrix 122.

The titanate-based coupling agent may be selected from at least one of titanium diisopropoxide bis(acetylacetonate) having the refractive index of 1.494, diisopropoxy-bisethylacetoacetatotitanate having the refractive index of 1.518, isopropyl trioleyl titanate having the refractive index of 1.477, isopropyl tri(dioctylpyrophosphate) titanate having the refractive index of 1.458, and titanium bis(triethanolamine) diisopropoxide having the refractive index of 1.488:
in which titanium diisopropoxide bis(acetylacetonate) is represented by the following structure:

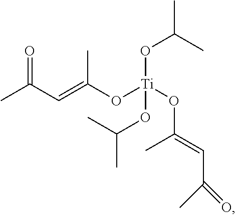

diisopropoxy-bisethylacetoacetatotitanate is represented by the following structure:

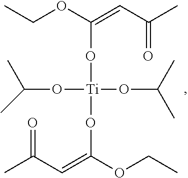

isopropyl trioleyl titanate is represented by the following structure:

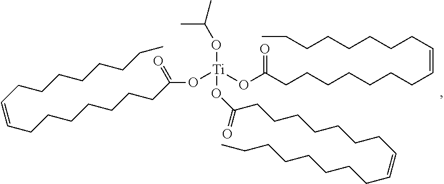

isopropyl tri(dioctylpyrophosphate) titanate is represented by the following structure:

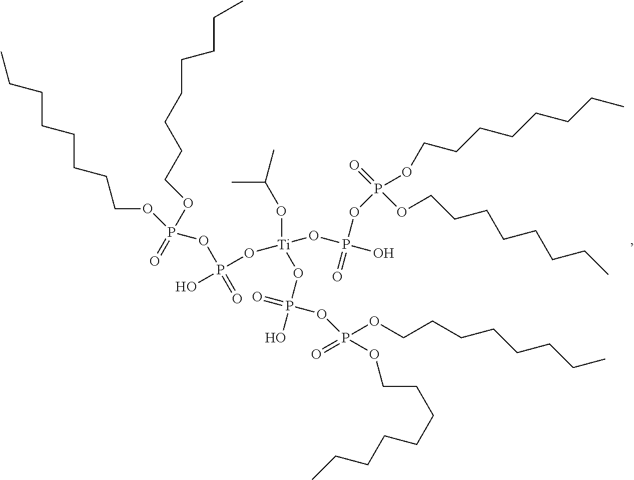

and titanium bis(triethanolamine)diisopropoxide is represented by the following structure:

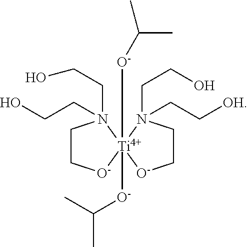

In some embodiments, the composite particulates 121 have a refractive index greater than 1.75 to obtain a significant refractive index difference from the first resin matrix 122, for example, 1.80, 1.85, 1.88, 1.90, 2.15, 2.25, 2.35, 2.45, 2.55, or the like.

By designing the difference between the refractive index of the composite particulates 121 and the refractive index of the first resin matrix 122 being greater than 0.25 and less than 1, a suitable haze of the anti-glare layer 100 can be obtained, thus obtaining a suitable anti-glare effect. For example, the difference may be 0.26, 0.28, 0.3, 0.4, 0.5, 0.6, 0.7, 0.8, 0.9, or the like.

In some embodiments, the first resin matrix 122 includes a first resin that may be formed by cross-linking a nine functional polyurethane.

Specifically, the first resin may be formed by the cross-linking of a first compound represented by the following structure:

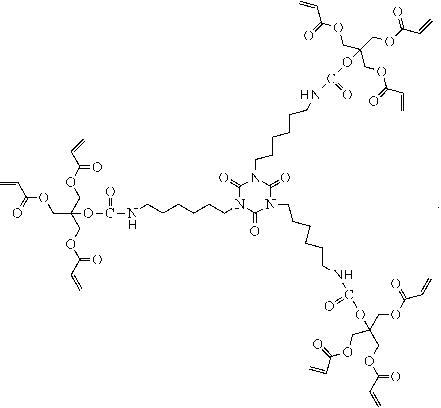 [SMILES: C=CC(=O)OCC(COC(=O)C=C)(COC(=O)C=C)OC(=O)NCCCCCCn1c(=O)n(CCCCCCNC(=O)OC(COC(=O)C=C)(COC(=O)C=C)COC(=O)C=C)c(=O)n(CCCCCCNC(=O)OC(COC(=O)C=C)(COC(=O)C=C)COC(=O)C=C)c1=O]

The first compound may be obtained by the reaction of 1,3,5-tris(6-isocyanatohexyl)-1,3,5-triazin-2,4,6-trione and pentaerythritol triacrylate, as shown in the following reaction:

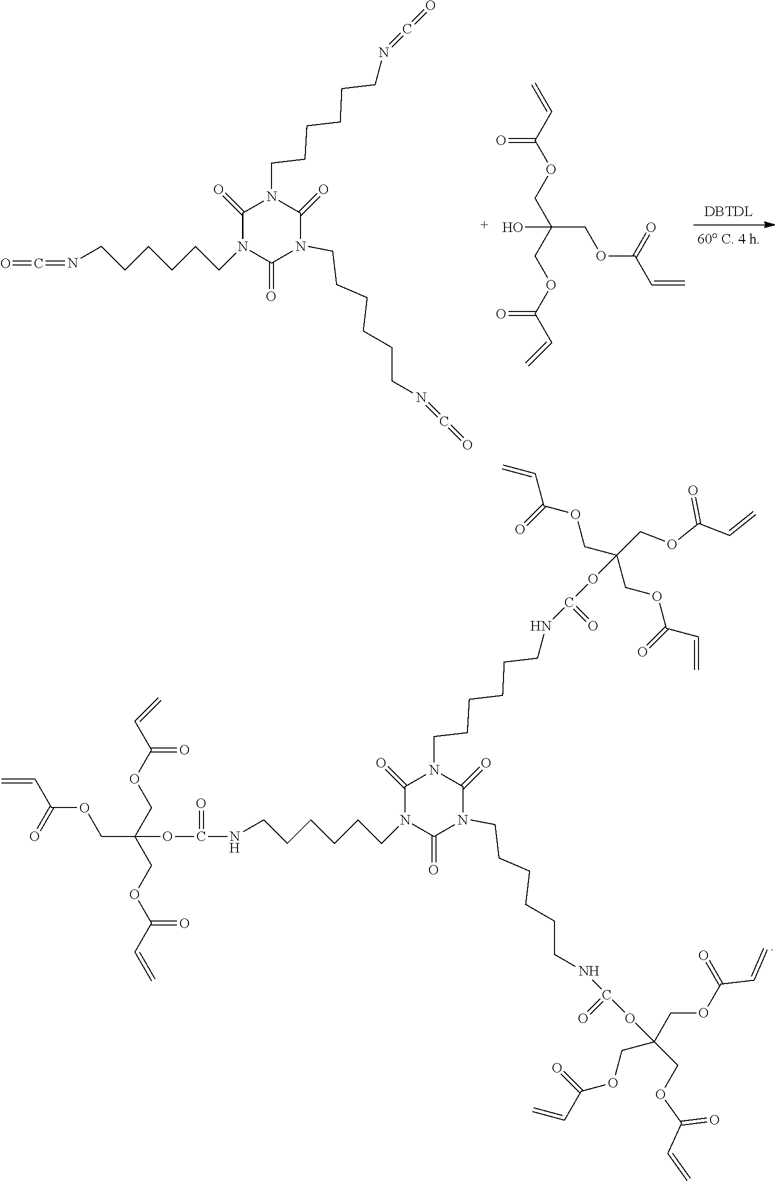

The main body of the anti-glare sub-layer 120 is formed by the first resin, and the composite particulates 121 are dispersed in the first resin.

In some embodiments, the first resin matrix 122 also includes a first active diluent, which is used to adjust the flexibility of the anti-glare sub-layer 120, avoiding cracks caused by excessive brittleness of the hardened sub-layer 130 and affecting the product quality of the anti-glare layer 100. The first active diluent may be selected from a trifunctional active diluent, a monofunctional active diluent, a bifunctional active diluent, or the like. Specifically, the first active diluent may be selected from at least one of trimethylolethane tri(meth)acrylate, trimethylolpropane tri(meth)acrylate, (meth)acrylic triglyceride, pentaerythritol tri(meth)acrylate, di (trimethylol propane) tri(meth)acrylate, dipentaerythritol tri(meth)acrylate, hydroxyethyl (meth)acrylate, isobornyl (meth)acrylate, 2-phenoxyethyl acrylate, lauryl acrylate, tetrahydrofurfuryl acrylate, diethylene glycol diacrylate, triethylene glycol diacrylate, poly(ethylene glycol) diacrylate, oxybis(methyl-2,1-ethanediyl) diacrylate, tri(propylene glycol) diacrylate, tricyclodecanedimethanol diacrylate, neopentyl glycol diacrylate, and 1,6-hexanediol diacrylate.

In some embodiments, the first resin matrix 122 also includes a first photoinitiator for cross-linking and curing the first compound to form the first resin. The first photoinitiator may be selected from at least one of a type I photoinitiator and a type II (a hydrogen grabbing type) photoinitiator. The type I photoinitiator is used to decompose molecules to generate free radicals through differences in chemical structures or molecular binding energy. The use of the type II (the hydrogen grabbing type) photoinitiator needs to introduce tertiary amine as a co-initiator. Preferably, the first photoinitiator may be selected from at least one of 4-phenoxydichloroacetophenone, 4-tert-butyldichloroacetophenone, diethoxyacetophenone, 4-tert-butyltrichloroacetophenone, 2-hydroxy-2-methylpropiophenone, 1-(4-isopropylphenyl)-2-hydroxy-2-methyl-1-propanone, 1-(4-dodecylphenyl)-2-hydroxy-2-methylpropan-1-one, 4-(2-hydroxyethoxy)-phenyl (2-hydroxy-2-propyl) ketone, 1-hydroxycyclohexyl phenyl ketone, benzoin, benzoin methyl ether, benzoin ethyl ether, benzyl dimethyl ketal, acyl phosphine oxide, a titanocene compound, benzophenone, benzoyl benzoic acid, benzoyl benzoic acid methyl ether, 4-benzoylbiphenyl, hydroxybenzophenone, 4-benzoyl-4′-methyldiphenylsulfide, 3,3′-dimethyl-4-methoxybenzophenone, thioxanthone, 2-chlorothiotonone, 2-methylthioxenone, 2,4-dimethylthioxenone, and isopropylthioxine.

In some embodiments, the composite particulates 121 are present in an amount ranging from 1 to 10 parts by weight, the first active diluent is present in an amount ranging from 5 to 20 parts by weight, and the first photoinitiator is present in an amount ranging from 1 to 10 parts by weight, based upon 100 parts by weight of the first resin in the anti-glare sub-layer 120, to obtain the anti-glare sub-layer 120 with an appropriate haze, thereby obtaining the anti-glare layer 100 having an appropriate anti-glare effect.

In some embodiments, the anti-glare sub-layer 120 is composed of the first resin, the composite particulates 121, the first active diluent, and the first photoinitiator. Raw materials of the anti-glare sub-layer 120 are composed of the first compound, a composite particulate dispersion, the first active diluent, the first photoinitiator, and a first solvent. The composite particulate dispersion is present in an amount ranging from 10 to 100 parts, the first active diluent is present in an amount ranging from 5 to 20 parts, the first photoinitiator is present in an amount ranging from 1 to 10 parts, and the first solvent is present in an amount ranging from 200 to 600 parts, based upon 100 parts by weight of the first resin in the raw materials of the anti-glare sub-layer 120, to obtain a suitable proportion of the raw materials of the anti-glare sub-layer 120.

In some embodiments, a boiling point of the first solvent is greater than or equal to 50° C. and less than or equal to 150° C., which is convenient for obtaining the first solvent that balances volatility and easy removability, thereby preventing from affecting a content of solid substances in the anti-glare sub-layer 120 and a thickness of the anti-glare sub-layer 120 finally formed. Specifically, the first solvent may be selected from at least one of alcohol, ester, ketone, and benzene solvent. For example, the first solvent may be selected from at least one of methanol, ethanol, isopropanol, ethyl acetate, propyl acetate, butyl acetate, acetone, butanone, cyclohexanone, toluene, and xylene.

In some embodiments, the anti-glare sub-layer 120 may be prepared by the raw materials of the anti-glare sub-layer 120 by a wet coating process. Specifically, the solvent in the raw materials is first dried and then cured by ultraviolet light to obtain the anti-glare sub-layer 120. The drying temperature is set ranging from 60° C. to 120° C., preferably from 80° C. to 100° C., for example, 85° C., 90° C., 95° C., or the like. The UV curing energy may range from 100 mj/cm² to 1000 mj/cm², preferably from 200 mj/cm² to 500 mj/cm², for example, 250 mj/cm², 300 mj/cm², 350 mj/cm², 400 mj/cm², 450 mj/cm², or the like.

In some embodiments, the hardened sub-layer 130 includes a second resin matrix, which is formed by the cross-linking of a second compound, the second compound may be a fifteen functional polyurethane.

Specifically, the second resin may be formed by the cross-linking of the second compound represented by the following structure:

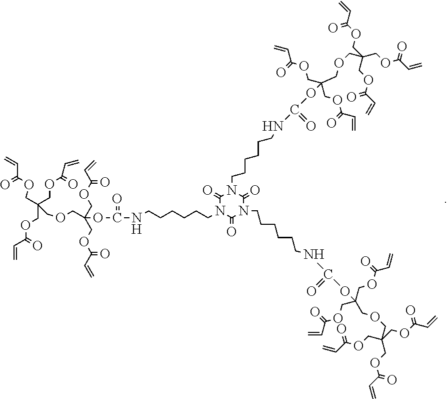 [SMILES: C=CC(=O)OCC(COCC(COC(=O)C=C)(COC(=O)C=C)OC(=O)NCCCCCCn1c(=O)n(CCCCCCNC(=O)OC(COCC(COC(=O)C=C)(COC(=O)C=C)COC(=O)C=C)(COC(=O)C=C)COC(=O)C=C)c(=O)n(CCCCCCNC(=O)OC(COCC(COC(=O)C=C)(COC(=O)C=C)COC(=O)C=C)(COC(=O)C=C)COC(=O)C=C)c1=O)(COC(=O)C=C)COC(=O)C=C]

The second compound may be obtained by the reaction of 1,3,5-tris(6-isocyanatohexyl)-1,3,5-triazin-2,4,6-trione and pentaerythritol pentaacrylate, as shown in the following reaction:

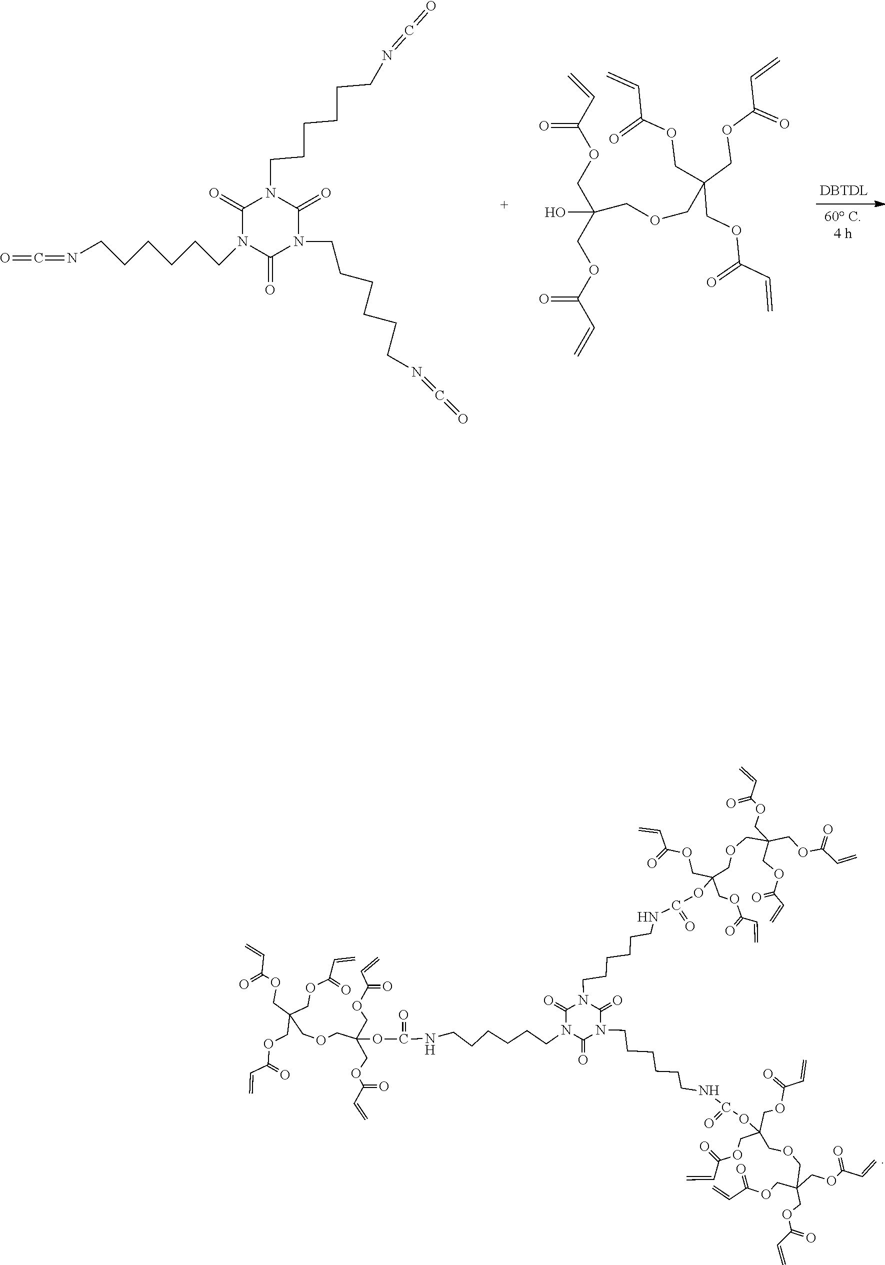 [SMILES: O=C=NCCCCCCn1c(=O)n(CCCCCCN=C=O)c(=O)n(CCCCCCN=C=O)c1=O ; C=CC(=O)OCC(O)(COCC(COC(=O)C=C)(COC(=O)C=C)COC(=O)C=C)COC(=O)C=C ; C=CC(=O)OCC(COCC(COC(=O)C=C)(COC(=O)C=C)OC(=O)NCCCCCCn1c(=O)n(CCCCCCNC(=O)OC(COCC(COC(=O)C=C)(COC(=O)C=C)COC(=O)C=C)(COC(=O)C=C)COC(=O)C=C)c(=O)n(CCCCCCNC(=O)OC(COCC(COC(=O)C=C)(COC(=O)C=C)COC(=O)C=C)(COC(=O)C=C)COC(=O)C=C)c1=O)(COC(=O)C=C)COC(=O)C=C]

The structure of the second compound is similar to the structure of the first compound, which is beneficial to enhancing the binding force between the hardened sub-layer 130 and the anti-glare sub-layer 120, reducing the risk of separation between the hardened sub-layer 130 and the anti-glare sub-layer 120, and improving the product quality of the anti-glare layer 100.

In some embodiments, the second resin matrix also includes a second active diluent, which has the similar effect to the first active diluent and is used to adjust the flexibility of the hardened sub-layer 130, avoiding cracks caused by excessive brittleness of the hardened sub-layer 130 and affecting the product quality of the anti-glare layer 100. The second active diluent may be selected from at least one of trimethylolethane tri(meth)acrylate, trimethylolpropane tri(meth)acrylate, (meth)acrylic triglyceride, pentaerythritol tri(meth)acrylate, di(trimethylol propane) tri(meth)acrylate, dipentaerythritol tri(meth)acrylate, hydroxyethyl (meth)acrylate, isobornyl (meth)acrylate, 2-phenoxyethyl acrylate, lauryl acrylate, tetrahydrofurfuryl acrylate, diethylene glycol diacrylate, triethylene glycol diacrylate, poly(ethylene glycol) diacrylate, oxybis(methyl-2,1-ethanediyl) diacrylate, tri(propylene glycol) diacrylate, tricyclodecanedimethanol diacrylate, neopentyl glycol diacrylate, and 1,6-hexanediol diacrylate.

In some embodiments, the second resin matrix further includes a second photoinitiator, which has an effect similar to the first photoinitiator and is used to cross-link and cure the second compound to form the second resin. The second photoinitiator may be selected from at least one of a type I photoinitiator and a type II (a hydrogen grabbing type) photoinitiator. The type I photoinitiator is used to decompose molecules to generate free radicals through differences in chemical structures or molecular binding energy. The use of the type II (the hydrogen grabbing type) photoinitiator needs to introduce tertiary amine as a co-initiator. Preferably, the second photoinitiator may be selected from at least one of 4-phenoxydichloroacetophenone, 4-tert-butyldichloroacetophenone, 4-tert-butyltrichloroacetophenone, diethoxyacetophenone, 2-hydroxy-2-methylpropiophenone, 1-(4-isopropylphenyl)-2-hydroxy-2-methyl-1-propanone, 1-(4-dodecylphenyl)-2-hydroxy-2-methylpropan-1-one, 4-(2-hydroxyethoxy)-phenyl (2-hydroxy-2-propyl) ketone, 1-hydroxycyclohexyl phenyl ketone, benzoin, benzoin methyl ether, benzoin ethyl ether, benzyl dimethyl ketal, acyl phosphine oxide, a titanocene compound, benzophenone, benzoyl benzoic acid, benzoyl benzoic acid methyl ether, 4-benzoylbiphenyl, hydroxybenzophenone, 4-benzoyl-4′-methyldiphenylsulfide, 3,3′-dimethyl-4-methoxybenzophenone, thioxanthone, 2-chlorothiotonone, 2-methylthioxenone, 2,4-dimethylthioxenone, and isopropylthioxine.

In some embodiments, the second active diluent is present in an amount ranging from 5 to 10 parts, and the second photoinitiator is present in an amount ranging from 1 to 10 parts, based upon 100 parts by weight of the first resin in the hardened sub-layer 130, to obtain the hardened sub-layer 130 with an appropriate hardness, thereby obtaining the anti-glare layer 100 with an appropriate hardness.

In some embodiments, the hardened sub-layer 130 is composed of the second resin matrix, and raw materials of the hardened sub-layer 130 are composed of the second compound, the second active diluent, the second photoinitiator, and a second solvent. The second active diluent is present in an amount ranging from 5 to 10 parts, the second photoinitiator is present in an amount ranging from 1 to 10 parts, and the second solvent is present in an amount ranging from 2000 to 4000 parts, based upon 100 parts by weight of the second resin in the raw materials of the hardened sub-layer 130, to obtain a suitable proportion of the raw materials of the hardened sub-layer 130.

In some embodiments, the second solvent is similar to the first solvent, with a boiling point greater than or equal to 50° C. and less than or equal to 150° C., so as to obtain the second solvent that balances volatility and easy removability, preventing from affecting a content of solid substances in the anti-glare sub-layer 120 and a thickness of the anti-glare sub-layer 120 finally formed. Specifically, the second solvent may be selected from at least one of alcohol, ester, ketone, and benzene solvent. For example, the second solvent may be selected from at least one of methanol, ethanol, isopropanol, ethyl acetate, propyl acetate, butyl acetate, acetone, butanone, cyclohexanone, toluene, and xylene.

In some embodiments, the hardened sub-layer 130 may be prepared by the raw materials of the hardened sub-layer 130 on a side of the anti-glare sub-layer 120 away from the substrate 110 by a wet coating process. Specifically, the solvent in the raw materials is first dried and then cured by ultraviolet light to obtain the hardened sub-layer 130. The drying temperature is set ranging from 60° C. to 120° C., preferably from 80° C. to 100° C., for example, 85° C., 90° C., 95° C., or the like. The UV curing energy may range 100 mj/cm² to 1000 mj/cm², preferably from 200 mj/cm² to 500 mj/cm², for example, 250 mj/cm², 300 mj/cm², 350 mj/cm², 400 mj/cm², 450 mj/cm², or the like.

By setting the hardened sub-layer 130 on a side of the anti-glare sub-layer 120 away from the substrate 110, a surface of a side of the anti-glare sub-layer 120 away from the substrate 110 can be covered, which is conducive to covering the concave-convex structure of a surface of the hardened sub-layer 130, thereby protecting the anti-glare sub-layer 120 with the anti-glare function and improving the product quality of the anti-glare layer 100. Meanwhile, the hardness of the hardened sub-layer 130 is greater than the hardness of the anti-glare sub-layer 120, which is beneficial to improving the product quality of the anti-glare layer 100.

In some embodiments, a thickness of the anti-glare sub-layer 120 is greater than or equal to 1 micrometer and less than or equal to 10 micrometers. Preferably, the thickness of the anti-glare sub-layer 120 is greater than or equal to 3 micrometers and less than or equal to 5 micrometers, for example, it may be 3.5 micrometers, 4 micrometers, 4.5 micrometers, or the like, to obtain the anti-glare sub-layer 120 having an appropriate anti-glare effect.

In some embodiments, the thickness of the anti-glare sub-layer 120 is greater than or equal to 1 micrometer and less than or equal to 3 micrometers, for example, it may be 1.5 micrometers, 2 micrometers, 2.5 micrometers, or the like, to obtain the anti-glare sub-layer 120 having an appropriate hardness.

In some embodiments, adding different parts by weight of the composite particulates 121 to the anti-glare sub-layer 120 is beneficial to adjusting the haze of the anti-glare layer 100, so that the haze of the anti-glare layer 100 is greater than or equal to 5% and less than or equal to 65%, for example, it may be 10%, 20%, 30%, 40%, 50%, 60%, or the like.

In some embodiments, the substrate 110 may be a flexible substrate. For example, the flexible substrate may include at least one of cellulose triacetate, polyethylene terephthalate, and polyimide. Alternatively, the substrate 110 may be a rigid substrate, for example, a glass substrate, or the like.

In some embodiments, a pencil hardness of the anti-glare layer 100 is greater than or equal to 4 H, which can be obtained by using Mitsubishi pencils with different hardness, under a load of 500 g, 5 lines are marked on a surface of the hardened sub-layer 130 of the anti-glare layer 100, and then observing whether the anti-glare layer 100 has scratches.

In some embodiments, the anti-glare layer 100 has scratch resistance greater than or equal to 50 cycles, which is tested using an abrasion tester. Under a load of 500 g, a surface of the hardened sub-layer 130 of the anti-glare layer 100 is repeatedly scraped using a 000 type steel velvet, and then observing whether the anti-glare layer 100 has scratches.

The embodiments of the present disclosure improve the mechanical property of the anti-glare layer 100 and protects the anti-glare sub-layer 120 with an anti-glare function by setting the hardened sub-layer 130 on a side of the anti-glare sub-layer 120. Moreover, by using the composite particulates 121 in the anti-glare sub-layer 120, and making the difference between the refractive index of the composite particulates 121 and the refractive index of the first resin matrix 122 of the anti-glare sub-layer 120 being greater than 0.25, a good anti-glare performance can be obtained.

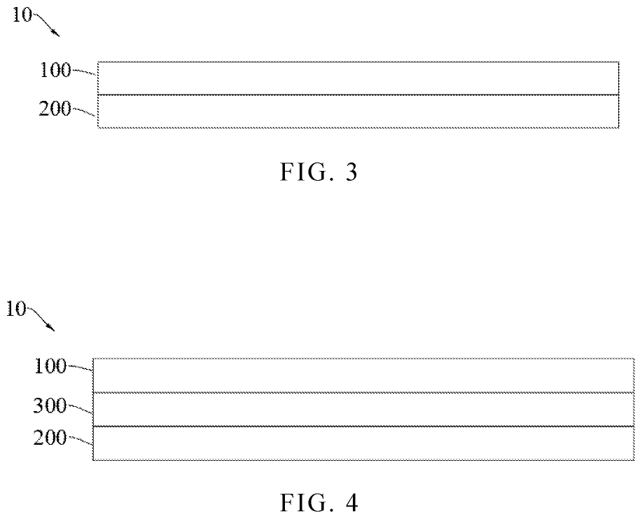

Referring to FIG. 3 and FIG. 4. The embodiments of the present disclosure further provide a display device 10 that includes the anti-glare layer 100 as described above.

In some embodiments of the present disclosure, the display device 10 further includes a display panel 200, and the anti-glare layer 100 is disposed on a light output side of the display panel 200. The anti-glare layer 100 is directly attached to the light output side of the display panel 200 (as shown in FIG. 3), or the display device 10 also includes a polarizer 300 disposed on the light output side of the display panel 200, and the anti-glare layer 100 is attached to a side of the polarizer 300 away from the display panel 200 (as shown in FIG. 4).

In some embodiments, the anti-glare layer 100 is attached to a side of the polarizer 300 away from the display panel 200, and the polarizer 300 includes a surface coating layer on a side away from the display panel 200. The surface coating layer may be disposed in the same layer as the anti-glare layer 100, that is, the anti-glare layer 100 is reused as the surface coating layer of the polarizer 300.

Next, the present disclosure will be described with reference to some examples in more detail. However, it should be noted that these examples are provided for illustrative purposes only and should not be construed in any way as limiting the present disclosure.

### Example 1

Preparation of the composite particulate dispersion 1:2 g of titanium oxide with a particle size of 3 um and 180 mL of toluene were added to a 500 mL of a three-necked flask, and ultrasonically dispersed for 0.5 hour at room temperature. Subsequently, a mixture of 2 g of isopropyl trioleate acyloxytitanate and 100 ml of toluene was added to the three-necked flask in an Argon (Ar) atmosphere and stirred for 5 hours at a temperature of 70° C. After the reaction was completed, the titanium oxide dispersion was centrifuged (15,000 rpm) for 0.5 hour, and the supernatant was poured off to obtain the lower solid substance. The solid substance was sonicated and dispersed in 30 mL of tert-butanol for 10 minutes, followed by centrifugation (15,000 rpm) for 0.5 hour. After the supernatant was removed, the solid substance was ultrasonically dispersed in 30 mL of tert-butanol to obtain the composite particulate dispersion 1 with a refractive index of 1.81.

Preparation of the first resin 1:54 g of 1,3,5-tris(6-isocyanatohexyl)-1,3,5-triazin-2,4,6-trione, 96 g of pentaerythritol triacrylate, and 150 g of ethyl acetate were added to a 500 mL of a three-necked flask, and dispersed at room temperature for 0.5 hour. Subsequently, 0.15 g of dibutyltin dilaurate was added to the three-necked flask in an Ar atmosphere, and the reaction mixture was stirred at a temperature of 60° C. for 4 hours.

Preparation of the raw materials for the anti-glare sub-layer 1:34 g of the composite particulate dispersion 1, 8 g of the first resin 1, 1 g of tricyclodecanedimethanol diacrylate, 0.05 g of 1,1′-(methylene-di-4,1-phenylene) bis [2-hydroxy-2-methyl-1-propanone] used as the photoinitiator, and 10 g of butanone were mixed and stirred to form the raw materials for the anti-glare sub-layer1.

Preparation of the second resin 1:36 g of 1,3,5-tris(6-isocyanatohexyl)-1,3,5-triazin-2,4,6-trione, 114 g of dipentaerythritol pentaacrylate, and 150 g of methyl isobutyl ketone were added to a 500 mL of a three-necked flask, and dispersed at room temperature for 0.5 hour. Subsequently, 0.15 g of dibutyltin dilaurate was added to the three-necked flask in an Ar atmosphere, and the reaction mixture was stirred at a temperature of 60° C. for 4 hours.

Preparation of the raw materials for the hardened sub-layer 1:80 g of the second resin 1, 1 g of isobornyl acrylate, 0.09 g of 1,1′-(methylene-di-4,1-phenylene) bis [2-hydroxy-2-methyl-1-propanone] used as the photoinitiator, and 170 g of butanone were mixed and stirred to form the raw materials for the hardened sub-layer 1.

The test results of the anti-glare layer formed by the anti-glare sub-layer 1 and the hardened sub-layer 1 obtained through the above-mentioned methods are listed as follows:
a haze of 50%, a pencil hardness of 4H, and a scratch resistance of 60 cycles.

### Example 2

Preparation of the composite particulate dispersion 2:2 g of zirconia with a particle size of 5 um and 180 mL of toluene were added to a 500 mL of a three-necked flask, and ultrasonically dispersed at room temperature for 0.5 hour. Subsequently, a mixture of 2 g of diisopropoxy-bisethylacetoacetatotitanate and 100 mL of toluene was added to the three-necked flask in an Ar atmosphere, and the reaction mixture was stirred at a temperature of 70° C. for 5 hours. After the reaction was completed, the titanium oxide dispersion was centrifuged (15,000 rpm) for 0.5 hour, and the supernatant was poured off to obtain the lower solid substance. The solid substance was sonicated and dispersed in 30 mL of tert-butanol for 10 minutes, followed by centrifugation (15,000 rpm) for 0.5 hour. After the supernatant was removed, the solid substance was ultrasonically dispersed in 30 mL of tert-butanol to obtain the composite particulate dispersion 2 with a refractive index of 1.75.

Preparation of the first resin 2:54 g of 1,3,5-tris(6-isocyanatohexyl)-1,3,5-triazin-2,4,6-trione, 96 g of pentaerythritol triacrylate, and 150 g of ethyl acetate were added to a 500 mL of a three-necked flask, and dispersed at room temperature for 0.5 hour. Subsequently, 0.15 g of dibutyltin dilaurate was added to the three-necked flask in an Ar atmosphere, and the reaction mixture was stirred at a temperature of 60° C. for 4 hours.

Preparation of the raw materials for the anti-glare sub-layer 2:34 g of the composite particulate dispersion 2, 80 g of the first resin 2, 1 g of 1,6-hexanediol diacrylate, 0.05 g of 1-hydroxycyclohexylphenyl ketone used as the photoinitiator, and 5 g of butanone were mixed and stirred to form the raw materials for the anti-glare sub-layer 2.

Preparation of the second resin 2:36 g of 1,3,5-tris(6-isocyanatohexyl)-1,3,5-triazin-2,4,6-trione, 114 g of dipentaerythritol pentaacrylate, and 150 g of methyl isobutyl ketone were added to a 500 mL of a three-necked flask, and dispersed at room temperature for 0.5 hour. Subsequently, 0.15 g of dibutyltin dilaurate was added to the three-necked flask in an Ar atmosphere, and the reaction mixture was stirred at a temperature of 60° C. for 4 hours.

Preparation of the raw materials for the hardened sub-layer 2:80 g of the matrix resin of the hardened coating layer, 1 g of trimethylolpropane trimethacrylate, 0.09 g of 1-hydroxycyclohexylphenyl ketone used as the photoinitiator, and 100 g of ethyl acetate were mixed and stirred to form the raw materials for the hardened sub-layer 2.

The test results of the anti-glare layer formed by the anti-glare sub-layer 2 and the hardened sub-layer 2 obtained through the above-mentioned methods are listed as follows:
a haze of 10%, a pencil hardness of 5H, and a scratch resistance of 80 cycles.

It can be seen from example 2 that the anti-glare layer obtained in the present disclosure combines the haze, the hardness, and the scratch resistance, and thus has a good anti-glare function, a good hardness, and a good scratch resistance.

Embodiments of the present disclosure provide the anti-glare layer and the display device; the anti-glare layer includes the substrate, the anti-glare sub-layer disposed on a side of the substrate, and the hardened sub-layer disposed on a side of the anti-glare sub-layer away from the substrate; the anti-glare sub-layer includes the first resin matrix and the composite particulates dispersed in the first resin matrix; the composite particulates include the metal oxide particulates and the titanate-based compound connected to a surface of the metal oxide particulates; and the difference between the refractive index of the composite particulates and a refractive index of the first resin matrix is greater than 0.25. The present disclosure improves the mechanical property of the anti-glare layer and protects the anti-glare sub-layer with an anti-glare function by setting the hardened sub-layer on a side of the anti-glare sub-layer. Moreover, by using the composite particulates in the anti-glare sub-layer, and making the difference between the refractive index of the composite particulates and the refractive index of the first resin matrix of the anti-glare sub-layer being greater than 0.25, a good anti-glare performance can be obtained.

The anti-glare layer and the display device provided by the embodiments of the present disclosure are described in detail. In this context, specific embodiments are adopted to illustrate a principle and implementation modes of the present disclosure. The description of the above-mentioned embodiments is only used to help understand a principle and core ideas of the present disclosure. At the same time, for those skilled in the art, there will be changes in implementation modes and a scope of the present disclosure. In conclusion, contents of the specification should not be interpreted as a limitation of the present disclosure.

What is claimed is:

1. An anti-glare layer comprising:
a substrate;
an anti-glare sub-layer disposed on a side of the substrate; and
a hardened sub-layer disposed on a side of the anti-glare sub-layer away from the substrate;
wherein the anti-glare sub-layer comprises a first resin matrix and composite particulates dispersed in the first resin matrix, and the composite particulates comprise metal oxide particulates and a titanate-based compound connected to a surface of the metal oxide particulates; and
wherein a difference between a refractive index of the composite particulates and a refractive index of the first resin matrix is greater than 0.25.

2. The anti-glare layer of claim 1, wherein the composite particulates have a particle size greater than or equal to 1 micrometer and less than or equal to 10 micrometers.

3. The anti-glare layer of claim 1, wherein the composite particles have a particle size greater than or equal to 3 micrometers and less than or equal to 5 micrometers.

4. The anti-glare layer of claim 1, wherein the titanate-based compound is formed by a titanate-based coupling agent, and a refractive index of the titanate-based coupling agent is greater than 1.45.

5. The anti-glare layer of claim 1, wherein the titanate-based compound is formed by a titanate-based coupling agent selected from at least one of titanium diisopropoxide bis(acetylacetonate), diisopropoxy-bisethylacetoacetatotitanate, isopropyl trioleyl titanate, isopropyl tri(dioctylpyrophosphate) titanate, and titanium bis(triethanolamine) diisopropoxide.

6. The anti-glare layer of claim 1, wherein the composite particulates have a refractive index greater than 1.75, and the difference between the refractive index of the composite particulates and the refractive index of the first resin matrix is less than 1.

7. The anti-glare layer of claim 1, wherein the metal oxide particles are selected from one or more of zirconia, titanium oxide, zinc oxide, antimony pentoxide, cerium oxide, and yttrium oxide.

8. The anti-glare layer of claim 1, wherein the first resin matrix comprises a first active diluent and a first photoinitiator;
wherein the first active diluent is selected from at least one of trimethylolethane tri(meth)acrylate, trimethylolpropane tri(meth)acrylate, (meth)acrylic triglyceride, pentaerythritol tri(meth)acrylate, di(trimethylol propane) tri(meth)acrylate, dipentaerythritol tri(meth)acrylate, hydroxyethyl (meth)acrylate, isobornyl (meth)acrylate, 2-phenoxyethyl acrylate, lauryl acrylate, tetrahydrofurfuryl acrylate, diethylene glycol diacrylate, triethylene glycol diacrylate, poly(ethylene glycol) diacrylate, oxybis(methyl-2,1-ethanediyl) diacrylate, tri(propylene glycol) diacrylate, tricyclodecanedimethanol diacrylate, neopentyl glycol diacrylate, and 1,6-hexanediol diacrylate; and
wherein the first photoinitiator is selected from at least one of 4-phenoxydichloroacetophenone, 4-tert-butyldichloroacetophenone, 4-tert-butyltrichloroacetophenone, diethoxyacetophenone, 2-hydroxy-2-methylpropiophenone, 1-(4-isopropylphenyl)-2-hydroxy-2-methyl-1-propanone, 1-(4-dodecylphenyl)-2-hydroxy-2-methylpropan-1-one, 4-(2-hydroxyethoxy)-phenyl (2-hydroxy-2-propyl) ketone, 1-hydroxycyclohexyl phenyl ketone, benzoin, benzoin methyl ether, benzoin ethyl ether, benzyl dimethyl ketal, acyl phosphine oxide, a titanocene compound, benzophenone, benzoyl benzoic acid, benzoyl benzoic acid methyl ether, 4-benzoylbiphenyl, hydroxybenzophenone, 4-benzoyl-4′-methyldiphenylsulfide, 3,3′-dimethyl-4-methoxybenzophenone, thioxanthone, 2-chlorothiotonone, 2-methylthioxenone, 2,4-dimethylthioxenone, and isopropylthioxine.

9. The anti-glare layer of claim 8, wherein the first resin matrix further comprises a first resin; and
wherein based upon 100 parts by weight of the first resin in the anti-glare sub-layer, the composite particulates are present in an amount ranging from 1 to 10 parts by weight, the first active diluent is present in an amount ranging from 5 to 20 parts by weight, and the first photoinitiator is present in an amount ranging from 1 to 10 parts by weight.

10. The anti-glare layer of claim 1, wherein the first resin matrix comprises a first resin formed by cross-linking a nine functional polyurethane.

11. The anti-glare layer of claim 1, wherein the first resin matrix comprises a first resin formed by cross-linking of a first compound represented by the following structure: [symbol]
.

12. The anti-glare layer of claim 1, wherein the hardened sub-layer comprises a second resin matrix, and the second resin matrix comprises a second resin formed by cross-linking a fifteen functional polyurethane.

13. The anti-glare layer of claim 1, wherein the hardened sub-layer comprises a second resin matrix, wherein the second resin matrix comprises a second resin formed by cross-linking a second compound represented by the following structure: [symbol]
.

14. The anti-glare layer of claim 1, wherein the hardened sub-layer comprises a second resin matrix, and the second resin matrix comprises a second active diluent and a second photoinitiator;
wherein the first active diluent is selected from at least one of trimethylolethane tri(meth)acrylate, trimethylolpropane tri(meth)acrylate, (meth)acrylic triglyceride, pentaerythritol tri(meth)acrylate, di(trimethylol propane) tri(meth)acrylate, dipentaerythritol tri(meth)acrylate, hydroxyethyl (meth)acrylate, isobornyl (meth)acrylate, 2-phenoxyethyl acrylate, lauryl acrylate, tetrahydrofurfuryl acrylate, diethylene glycol diacrylate, triethylene glycol diacrylate, poly(ethylene glycol) diacrylate, oxybis(methyl-2,1-ethanediyl) diacrylate, tri(propylene glycol) diacrylate, tricyclodecanedimethanol diacrylate, neopentyl glycol diacrylate, and 1,6-hexanediol diacrylate; and
wherein the second photoinitiator is selected from at least one of 4-phenoxydichloroacetophenone, 4-tert-butyldichloroacetophenone, diethoxyacetophenone, 4-tert-butyltrichloroacetophenone, 2-hydroxy-2-methylpropiophenone, 1-(4-isopropylphenyl)-2-hydroxy-2-methyl-1-propanone, 1-(4-dodecylphenyl)-2-hydroxy-2-methylpropan-1-one, 4-(2-hydroxyethoxy)-phenyl (2-hydroxy-2-propyl) ketone, 1-hydroxycyclohexyl phenyl ketone, benzoin, benzoin methyl ether, benzoin ethyl ether, benzyl dimethyl ketal, acyl phosphine oxide, a titanocene compound, benzophenone, benzoyl benzoic acid, benzoyl benzoic acid methyl ether, 4-benzoylbiphenyl, hydroxybenzophenone, 4-benzoyl-4′-methyldiphenylsulfide, 3,3′-dimethyl-4-methoxybenzophenone, thioxanthone, 2-chlorothiotonone, 2-methylthioxenone, 2,4-dimethylthioxenone, and isopropylthioxine.

15. The anti-glare layer of claim 14, wherein the second resin matrix further comprises a second resin; and
wherein based upon 100 parts by weight of the second resin in the hardened sub-layer, the second active diluent is present in an amount ranging from 5 to 10 parts by weight, and the second photoinitiator is present in an amount ranging from 1 to 10 parts by weight.

16. The anti-glare layer of claim 1, wherein a haze of the anti-glare layer is greater than or equal to 5% and less than or equal to 65%; and
wherein a pencil hardness of the anti-glare layer is greater than or equal to 4H.

17. The anti-glare layer of claim 1, wherein a thickness of the anti-glare sub-layer is greater than or equal to 1 micrometer and less than or equal to 10 micrometers.

18. A display device comprising a display panel and an anti-glare layer disposed on a light output side of the display panel, wherein the anti-glare layer comprises:
a substrate;
an anti-glare sub-layer disposed on a side of the substrate; and
a hardened sub-layer disposed on a side of the anti-glare sub-layer away from the substrate;
wherein the anti-glare sub-layer comprises a first resin matrix and composite particulates dispersed in the first resin matrix, and the composite particulates comprise metal oxide particulates and a titanate-based compound connected to a surface of the metal oxide particulates; and
wherein a difference between a refractive index of the composite particulates and a refractive index of the first resin matrix is greater than 0.25.

19. The display device of claim 18, wherein the anti-glare layer is attached to the light output side of the display panel.

20. The display device of claim 18, further comprising a polarizer disposed on the light output side of the display panel, wherein the anti-glare layer is attached to a side of the polarizer away from the display panel.
